(19) United States
(12) Patent Application Publication
(10) Pub. No.: US 2005/0190297 A1
(43) Pub. Date: Sep. 1, 2005

(54) Video signal processor and video display device

(76) Inventor: Junichi Kawata, Gunma-ken (JP)

Correspondence Address: Jonathan P. Osha;Osha & Liang LLP, Suite 2800, 1221 McKinney St., Houston, TX, 77010, US

(21) Appl. No.: 10/927,781

(22) Filed: Aug. 27, 2004

(30) Foreign Application Priority Data
Aug. 27, 2003 (JP) 2003-303532

(51) Int. Cl. H04N 5/50

(52) U.S. Cl. 348/569

(57) ABSTRACT

A video signal processor comprises a video signal receiving circuit for receiving a video signal from outside, and a sub-image signal generating circuit for generating an on-screen image signal corresponding to a fixed-pixel on-screen image to be displayed overlapping a video image. The video signal processor further comprises an interface circuit for converting the video signal received by the video signal receiving circuit into a fixed-pixel video signal, and synthesizing the converted video signal with the on-screen image signal generated by the sub-image signal generating circuit. The sub-image signal generating circuit generates the on-screen image signal to adjust the number of pixels included in the vertical direction in accordance with the generation scheme of the video signal.

### CROSS-REFERENCE TO RELATED APPLICATIONS

The priority Japanese application No. 2003-303532 upon which this patent application is based is hereby incorporated by reference.

### BACKGROUND OF THE INVENTION

1. Field of the Invention

The present invention relates to a video signal processor and video display device which enable display of on-screen images appropriate for video signals generated according to different schemes.

2. Description of the Related Art

In a television display device, On-Screen Display (OSD) is often used, in which a channel number, screen size, horizontal or vertical position, menu screen for adjusting display brightness, and the like are displayed overlapping a video image.

FIG. 8 shows a configuration of a video display device for displaying an NTSC video image and an on-screen image on a QVGA liquid crystal display. The video display device comprises a video signal processor 100 and a display 200. The video signal processor 100 includes a video signal receiving circuit 10, a sub-image signal generating circuit 20, and an interface 30.

The video signal receiving circuit 10 receives a video signal such as that of a television. The video signal receiving circuit 10 for receiving a television video signal may include components such as an antenna, tuner, and amplifier. The video signal receiving circuit 10 receives, for example, a television video signal transmitted over space, and outputs the received signal as a composite video signal.

The sub-image signal generating circuit 20 may be constituted with a control section 21, memory 22, horizontal counter 23, and vertical counter 24.

The memory 22 stores character data along with character sequence data constituting on-screen images. Character data is such that each character is composed of 12 pixels in the horizontal direction by 18 pixels in the vertical direction. The control section 21 receives from outside a signal designating an on-screen image to be displayed, and, in response to that signal, reads out from the memory 22 a character sequence data constituting the desired on-screen image. The control section 21 subsequently reads out from the memory 22 character data for characters constituting the desired on-screen image, and constructs an image data of the on-screen image as shown in FIG. 9. Because a QVGA liquid crystal display has a resolution of 480 pixels in the horizontal direction by 234 pixels in the vertical direction, the on-screen image is constructed satisfying the condition that the maximum number of characters that can be displayed are 40 characters in the horizontal direction by 13 characters in the vertical direction.

Subsequently, the control section 21 employs the horizontal counter 23 and the vertical counter 24 to arrange data for the individual pixels of the on-screen image in a format that can be written into a VRAM (Video RAM). The horizontal counter 23 is used as a counter for sequentially outputting data for each pixel along the horizontal direction of the on-screen image. The vertical counter 24 is used as a counter for sequentially outputting data for each group of horizontally-arranged pixels of the on-screen image. As shown in FIG. 10, the control section 21 sequentially arranges data for each pixel along the horizontal direction starting from pixel (0, 0) in the upper left corner of the image, while referring to the horizontal counter 23 being incremented by one at a time. After completion of data arrangement to pixel (479, 0) in the upper right corner, the horizontal counter 23 is reset, and the vertical counter 24 is incremented by one. Subsequently, the control section 21 sequentially arranges data for each pixel along the horizontal direction starting from pixel (0, 1), while referring to the horizontal counter 23 and the vertical counter 24. In this manner, pixel data arrangement along the horizontal direction is repeated while incrementing the vertical counter 24 by one at time to thereby produce an on-screen image signal.

The interface circuit 30 receives the video signal from the video signal receiving circuit 10 and the on-screen image signal from the sub-image signal generating circuit 20, and synthesizes these received image signals into a signal that can be displayed on the display. The interface circuit 30 first samples the video signal for conversion into a signal for a fixed-pixel device having 480×234 pixels, and then arranges the converted signal in a format for writing into a VRAM similarly as the on-screen image. The interface circuit 30 next allows the converted video signal and the on-screen image signal to be overlapped, so as to produce and output a synthesized signal composed of the video signal and the on-screen image signal.

The NTSC scheme widely employed in Japan and in North, Central, and South America adopts an interlace mode in which the number of horizontal scan lines is 525. Among 262 scan lines that are scanned at one time in the NTSC scheme, 234 scan lines are actually used for display. This number matches with the number of pixels along the vertical direction of a QVGA liquid crystal display, which is also 234. Accordingly, an NTSC video signal can be overlapped and displayed with an on-screen image without performing any compression along the horizontal and vertical directions.

On the other hand, the PAL scheme widely employed in Europe, Asia, and Africa adopts an interlace mode in which the number of horizontal scan lines is 625. Among the scan lines that are scanned at one time, 270 scan lines are actually used for display. In order to display a PAL video signal on a QVGA liquid crystal display, it is necessary to compress the 270 scan lines provided along the vertical direction to match with the 234 pixels provided along the vertical direction of the display.

However, if a compression circuit 32 is provided subsequent to the interface circuit 30 as shown in FIG. 11 and compression processing is performed after the video signal and the on-screen image signal are synthesized, the on-screen image would be compressed together with the video signal. In this case, it would not be possible to display the on-screen image over the entire screen of the QVGA liquid crystal display.

In order to avoid this problem, compression processing may be performed on the video signal before synthesizing the video signal with the on-screen image signal, as shown in FIG. 13. However, this method would require that considerable changes be made in the circuit configuration of the NTSC system shown in FIG. 8. Further, fabrication costs would increase along with the complex circuitry required by this method.

### SUMMARY OF THE INVENTION

The present invention provides a video signal processor comprising a video signal receiving circuit for receiving a video signal, and a sub-image signal generating circuit for generating an on-screen image signal corresponding to a fixed-pixel on-screen image to be displayed overlapping a video image. The video signal processor further comprises an interface circuit for converting the video signal received by the video signal receiving circuit into a fixed-pixel video signal, and synthesizing the converted video signal with the on-screen image signal generated by the sub-image signal generating circuit. The sub-image signal generating circuit generates the on-screen image signal to include a number of pixels in the vertical direction changed in accordance with the generation scheme of the video signal.

The present invention provides a video signal display device comprising a video signal receiving circuit for receiving a video signal, and a sub-image signal generating circuit for generating an on-screen image signal corresponding to a fixed-pixel on-screen image to be displayed overlapping a video image. The video signal display device further comprises an interface circuit for converting the video signal received by the video signal receiving circuit into a fixed-pixel video signal, and synthesizing the converted video signal with the on-screen image signal generated by the sub-image signal generating circuit. The video signal display device also comprises a fixed-pixel display for visually displaying a video signal output from the interface circuit. The sub-image signal generating circuit generates the on-screen image signal to include a number of pixels in the vertical direction changed in accordance with the generation scheme of the video signal.

### BRIEF DESCRIPTION OF THE DRAWINGS

FIG. 1 is a block diagram showing a configuration of a video display device according to an embodiment of the present invention.

FIGS. 2(a) and 2(b) show the maximum numbers of characters that can be displayed in an on-screen image according to the NTSC and PAL schemes, respectively.

FIG. 3 shows configuration data of on-screen images stored and maintained in a memory.

FIG. 4 is a block diagram showing another configuration of a video display device according to an embodiment of the present invention.

FIG. 5 shows an on-screen image signal for the PAL scheme according to an embodiment of the present invention.

FIGS. 6(a) and 6(b) are diagrams for explaining synthesis of a video signal and an on-screen signal according to an embodiment of the present invention.

FIG. 7 is a diagram for explaining compression processing performed in a compression circuit according to an embodiment of the present invention.

FIG. 8 is a block diagram showing a configuration of a conventional video display device.

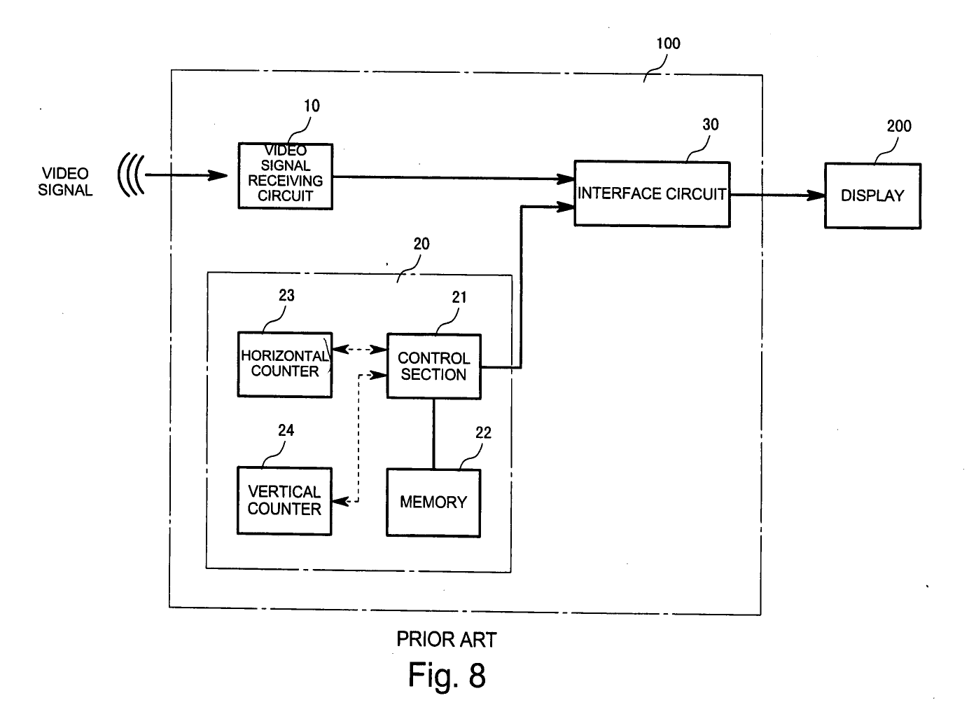

FIG. 9 is a diagram for explaining a screen configuration of an on-screen image.

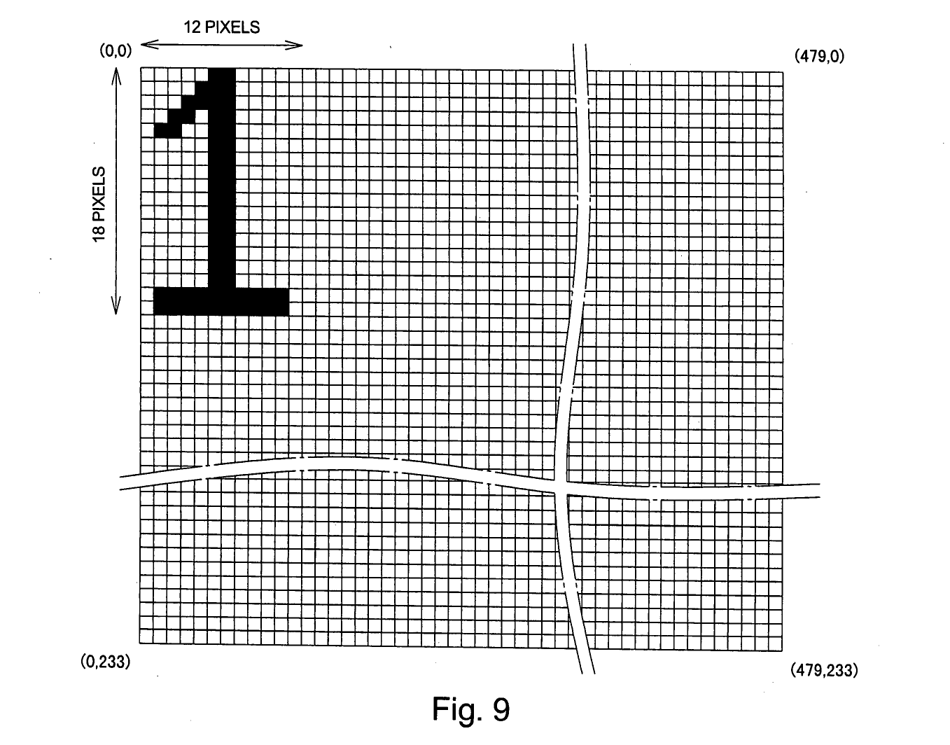

FIG. 10 shows an on-screen image signal for the NTSC scheme.

FIG. 11 is a block diagram showing another configuration of a conventional video display device.

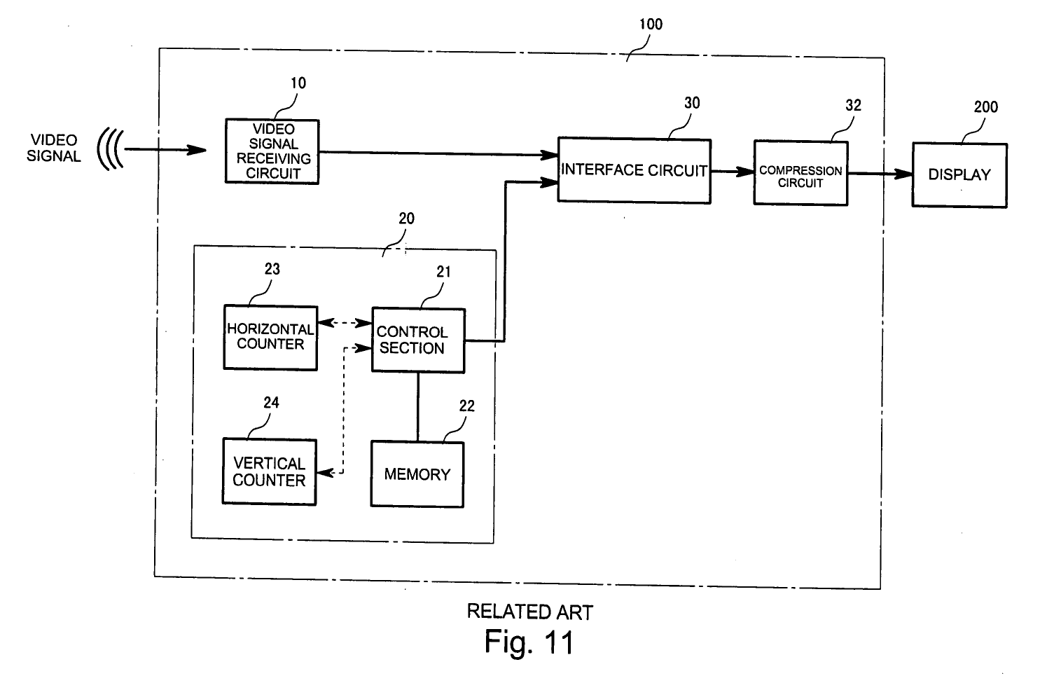

FIG. 12 is a diagram for explaining conventional synthesis and compression of a video signal and an on-screen signal processing.

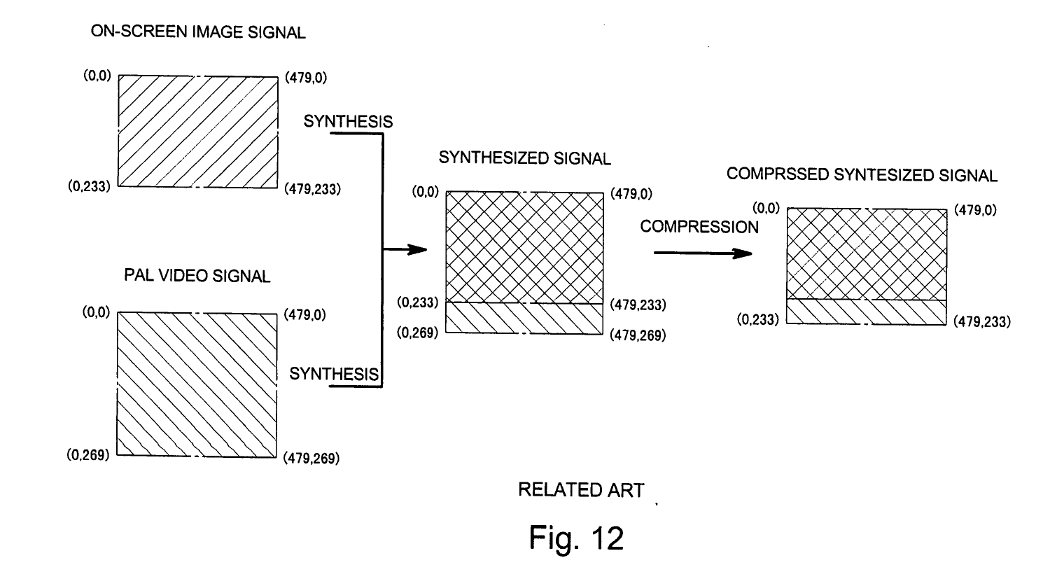

FIG. 13 is a block diagram showing a further configuration of a conventional video display device.

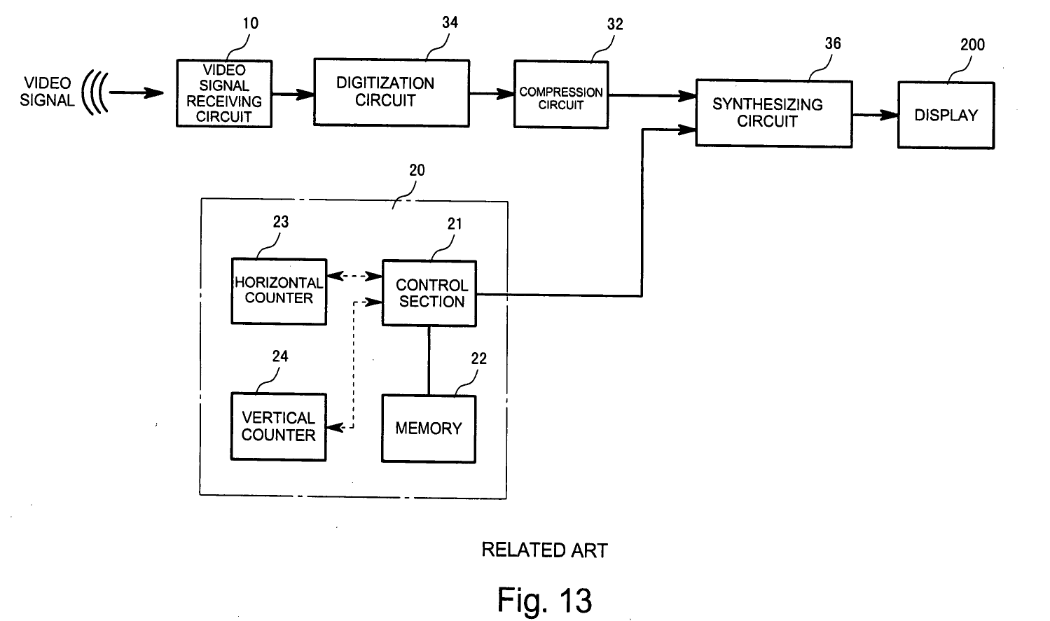

### DESCRIPTION OF THE PREFERRED EMBODIMENTS

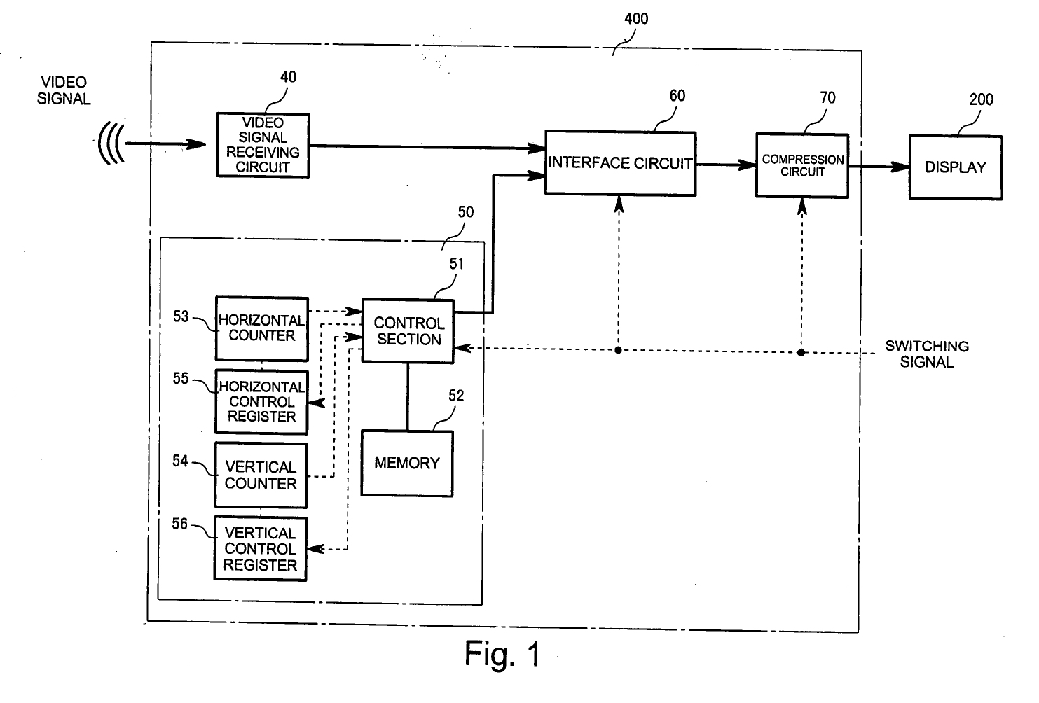

As shown in FIG. 1, a video display device according to a preferred embodiment of the present invention includes a video signal processor 400 and a display 200. The video signal processor 400 comprises a video signal receiving circuit 40, sub-image signal generating circuit 50, interface circuit 60, and compression circuit 70. The display 200 is a fixed-pixel display such as a liquid crystal display or a plasma display. In the present embodiment, the display 200 is described as a QVGA display having a resolution of 480 pixels in the horizontal direction by 234 pixels in the vertical direction.

The video signal receiving circuit 40 receives a video signal such as that of a television broadcast. The video signal receiving circuit 40 according to the present embodiment is adapted to receive video signals generated according to different schemes. For example, the video signal receiving circuit 40 can receive both a video signal of the NTSC scheme widely employed in Japan and in North, Central, and South America, and a video signal of the PAL scheme widely employed in Europe, Asia, and Africa. The video signal receiving circuit 40 may be constituted as a conventional television receiver circuit including components such as an antenna, tuner, demodulator circuit, and amplifier. However, it should be noted that all of these components need not be provided within one unit, as long as the video signal receiving circuit 40 can receive a video signal supplied from outside the unit. The received signal is output as a composite video signal in which a synchronization signal and pixel information are combined.

The sub-image signal generating circuit 50 comprises a control section 51, memory 52, horizontal counter 53, vertical counter 54, horizontal control register 55, and vertical control register 56.

The memory 52 stores character data along with character sequence data constituting each on-screen image. Character data is such that each character is composed of 12 pixels in the horizontal direction by 18 pixels in the vertical direction. The control section 51 receives from outside a signal designating an on-screen image to be displayed, and, in response to that signal, reads out from the memory 52 a character sequence data constituting the desired on-screen image.

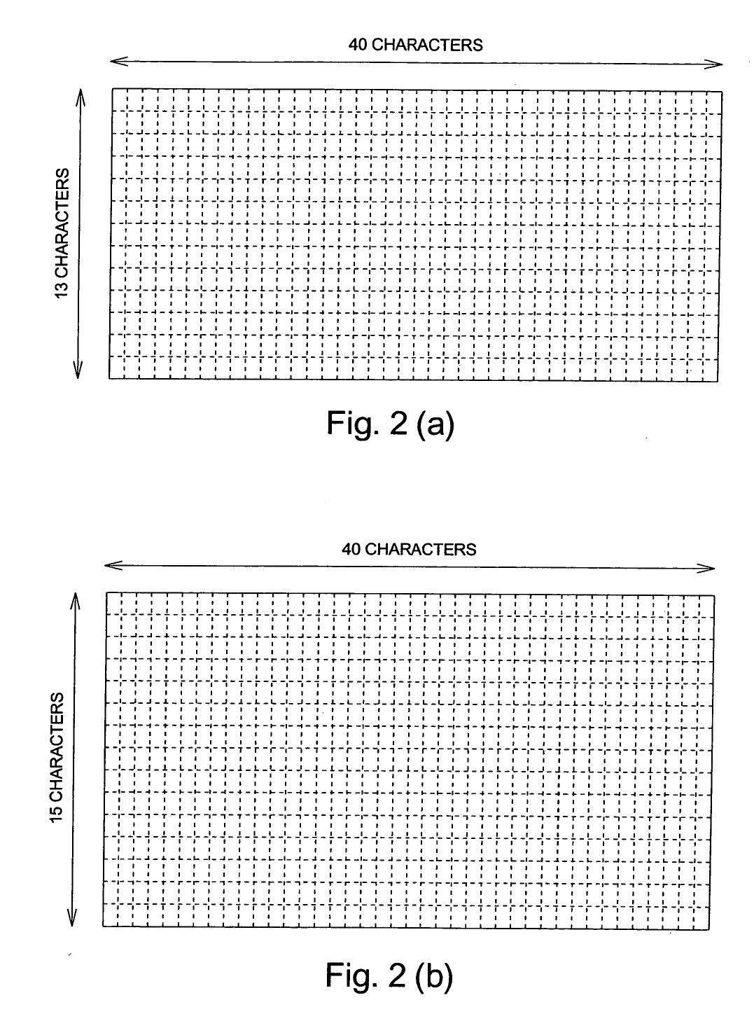

The control section 51 subsequently reads out from the memory 52 character data for characters constituting the desired on-screen image, so as to construct an image data of the on-screen image. When the video signal received by the video signal receiving circuit 40 is of the NTSC scheme, the on-screen image is constructed satisfying the condition that the maximum number of characters that can be displayed are 40 characters in the horizontal direction by 13 characters in the vertical direction, as shown in FIG. 2(a). On the other hand, when the video signal received by the video signal receiving circuit 40 is of the PAL scheme, the on-screen image is constructed satisfying the condition that the maximum number of characters that can be displayed are 40 characters in the horizontal direction by 15 characters in the vertical direction, as shown in FIG. 2(b).

As a result of the above, because each character is composed of 12×18 pixels, an NTSC on-screen image would comprise 480×234 pixels, while a PAL on-screen image would comprise 480×270 pixels.

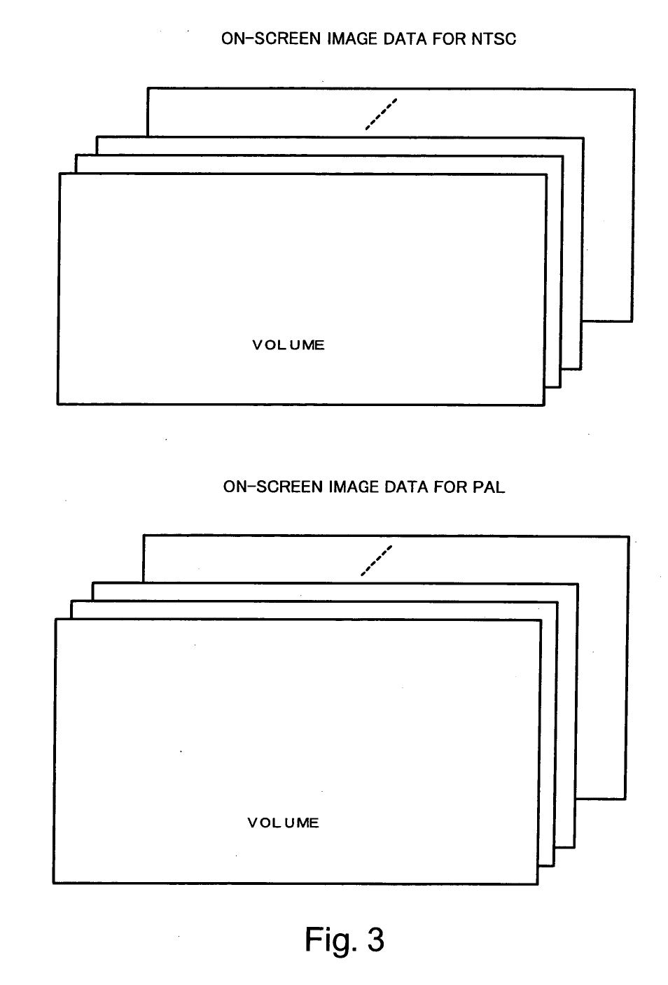

More specifically, as shown in FIG. 3, the memory 52 separately stores and maintains constructed data for each on-screen image for the NTSC scheme (including the maximum of 40×13 characters) and configuration data for each on-screen image for the PAL scheme (including the maximum of 40×15 characters). With this arrangement, either of the NTSC or PAL schemes can be selected in accordance with a switching signal supplied from outside for designating a video signal scheme. Also, a screen type may be selected in accordance with a screen selection signal.

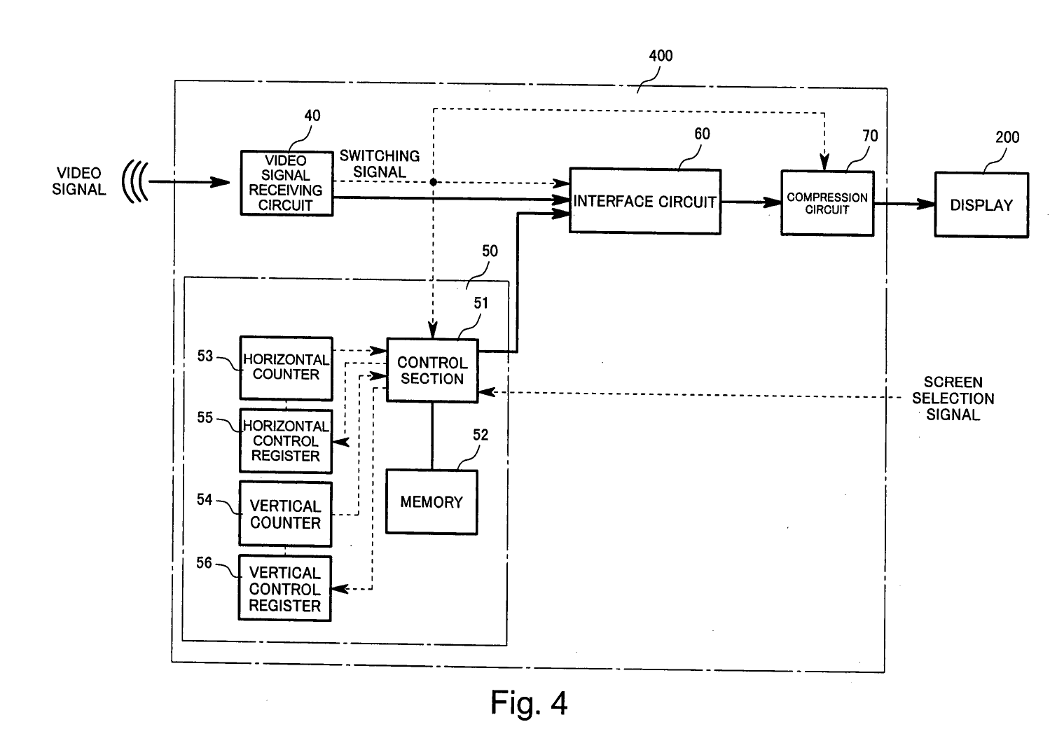

Further, it is also possible to allow the video signal receiving circuit 40 to automatically determine the scheme of the video signal based on features unique to the respective schemes of video signals to be received. When employing this configuration, it is preferable to allow a switching signal denoting the video signal scheme determined by the video signal receiving circuit 40 to be output to the sub-image signal generating circuit 50 as illustrated in FIG. 4, such that constructed data of an on-screen image signal can be automatically selected.

For example, according to the NTSC scheme, 525 scan lines are provided, and an NTSC video signal supplies 30 frames per second. According to the PAL scheme, 625 scan lines are provided, and a PAL video signal supplies 25 frames per second. It is therefore possible to determine the scheme of a video signal based on these differences. Further, a video signal scheme may similarly be identified based on differences in horizontal scan frequency and vertical scan frequency which also vary depending on video signal schemes.

Subsequently, the control section 51 employs the horizontal counter 53 and the vertical counter 54 to arrange data for the individual pixels of the on-screen image in a format that can be written into a VRAM (Video RAM), so as to produce an on-screen image signal. The resulting on-screen image signal is output to the interface circuit 60.

The horizontal control register 55 is provided corresponding to the horizontal counter 53, and the vertical control register 56 is provided corresponding to the vertical counter 54. The horizontal counter 53 sequentially counts from zero to a value set in the horizontal control register 55, and serves as a counter for sequentially outputting data for each pixel along the horizontal direction of the on-screen image. The vertical counter 54 sequentially counts from zero to a value set in the vertical control register 56, and serves as a counter for sequentially outputting data for each group of horizontally-arranged pixels of the on-screen image.

In this manner, the sub-image signal generating circuit 50 is provided with the horizontal counter 53 for sequentially arranging data for each pixel along the horizontal direction of the on-screen image and the vertical counter 54 for sequentially arranging data for each group of horizontally-arranged pixels of the on-screen image. By making use of this arrangement, an on-screen image signal can be generated while changing, in accordance with a corresponding video signal scheme, the number to be counted by the vertical counter 54.

The control section 51 sets a maximum pixel number in the vertical control register 56 based on the switching signal. Specifically, when the NTSC scheme is employed, a value of 233 is set in the vertical control register 56. On the other hand, when the PAL scheme is employed, a value of 269 is set in the vertical control register 56. Further, a value of 479 is set in the horizontal control register 55, regardless of whether the video signal scheme is NTSC or PAL.

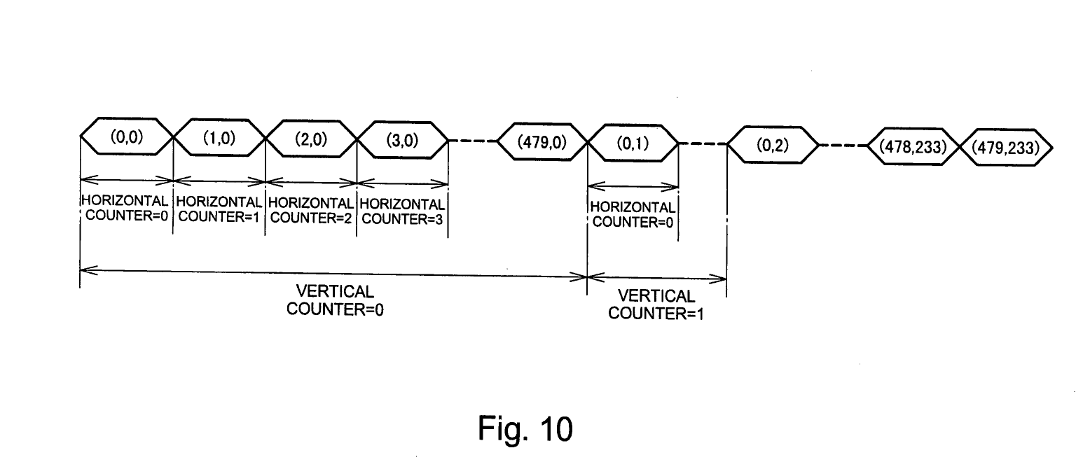

When the video signal scheme is NTSC, both the horizontal counter 53 and the vertical counter 54 start counting from zero. As shown in FIG. 10, the control section 51 sequentially arranges data for each pixel along the horizontal direction starting from pixel (0,0) in the upper left corner of the image, while referring to the horizontal counter 53 and the vertical counter 54. Because the horizontal counter 53 is incremented in units of one and the horizontal control register 55 is set to 479, pixel data are sequentially arranged up to pixel (479, 0) in the upper right corner. The horizontal counter 53 is next reset, and the vertical counter 54 is incremented in units of one. Subsequently, the control section 51 sequentially arranges data for each pixel along the horizontal direction starting from pixel (0, 1), while referring to the horizontal counter 53 and the vertical counter 54. In this manner, pixel data arrangement along the horizontal direction is repeated while incrementing the vertical counter 54 by one at a time. Because the vertical control register 56 is set to 233, pixel data arrangement is performed to pixel (479, 233) in the lower right corner, thereby completing output of the on-screen image signal.

In other words, as in a television signal of non-interlace mode, image data of the on-screen image are arranged in a manner of continuous scan from the upper left corner to the lower right corner, and output as the on-screen image signal.

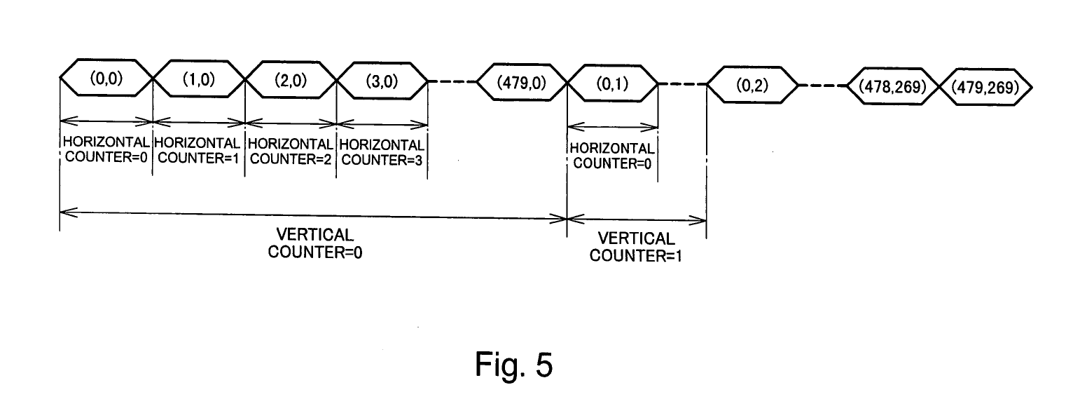

On the other hand, when the video signal scheme is PAL, the horizontal control register 55 is set to 479 while the vertical control register 56 is set to 269. Accordingly, as shown in FIG. 5, data from pixel (0, 0) in the upper left corner to pixel (479, 269) in the lower right corner are sequentially arranged and output.

In the above-described manner, the sub-image generating circuit 50 can generate an on-screen image signal including 234 pixels in the vertical direction when the video signal scheme is NTSC, and an on-screen image signal including 270 pixels in the vertical direction when the video signal scheme is PAL, while each character to be displayed in the on-screen image is constituted using 18 pixels in the vertical direction as mentioned above.

The interface circuit 60 receives the video signal from the video signal receiving circuit 40 and the on-screen image signal from the sub-image signal generating circuit 50, and synthesizes these received image signals into a signal that can be displayed on the display.

The interface circuit 60 samples the video signal received from the video signal receiving circuit 40 for conversion into a digital video signal having a number of pixels differed according to the video signal scheme. The interface circuit 60 first confirms, based on the switching signal, whether the video signal is according to the NTSC scheme or the PAL scheme. When the video signal scheme is NTSC, signal conversion is performed by sampling 480 times within one horizontal scan to obtain 480 pixels in the horizontal direction, and providing fixed pixels of 262 pixels in the vertical direction so as to match with the number of scan lines in one vertical scan. A typical video signal includes signal components that are not used for display. Accordingly, among the converted 262 pixels in the vertical direction, 234 pixels correspond to the actual display region.

When the video signal scheme is a PAL signal, signal conversion is performed by sampling 480 times within one horizontal scan to obtain 480 pixels in the horizontal direction, and providing fixed pixels of 312 pixels in the vertical direction to match with the number of scan lines in one vertical scan. Among the converted 312 pixels in the vertical direction, 270 pixels correspond to the actual display region.

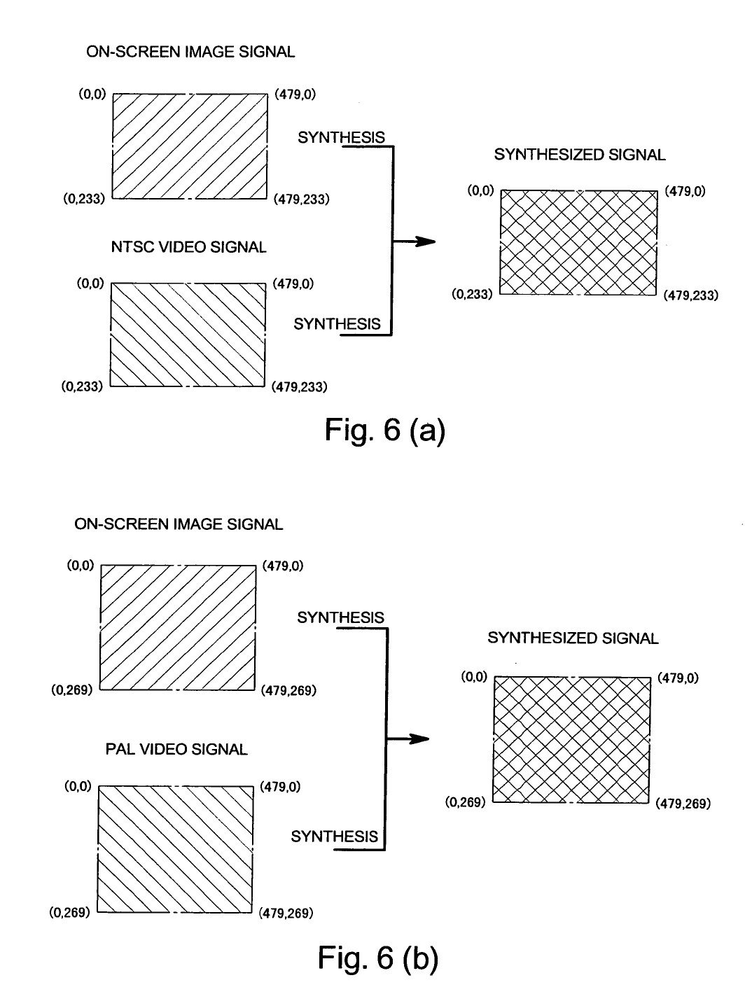

Subsequently, the converted video signal and the on-screen image signal are overlapped so as to produce and output a synthesized signal composed of the video signal and the on-screen image signal. When the NTSC scheme is employed, the on-screen image signal is constructed to include 480 pixels in the horizontal direction by 234 pixels in the vertical direction. With this pixel configuration matching with the number of pixels of the NTSC video signal, signal synthesis can be performed simply as shown in FIG. 6(a). Further, when the PAL scheme is employed, the on-screen image signal is constructed to include 480 pixels in the horizontal direction by 270 pixels in the vertical direction. With this pixel configuration matching with the number of pixels of the PAL video signal, signal synthesis can be performed simply as shown in FIG. 6(b).

In the arrangement as described above, the switching signal may be input from outside as shown in FIG. 1. Alternatively, as shown in FIG. 4, the video signal receiving circuit 40 may be configured to automatically determine the scheme of the video signal and output a switching signal to the interface circuit 60.

Further, a compression circuit for compressing a signal output from the interface circuit 60 may be provided. When performing compression using such a compression circuit, it is preferable to change the compression ratio according to the scheme of the video signal.

The compression circuit 70 serves to perform compression on the synthesized image signal output from the interface circuit 60. The compression circuit 70 first confirms based on the switching signal whether the video signal is according to the NTSC or PAL scheme. When the video signal scheme is NTSC, the compression circuit 70 performs no compression because the number of pixels of the synthesized image signal matches with QVGA resolution. On the other hand, when the video signal scheme is PAL, 273 pixels in the vertical direction of the synthesized image signal are compressed to 234 pixels to thereby match with QVGA resolution.

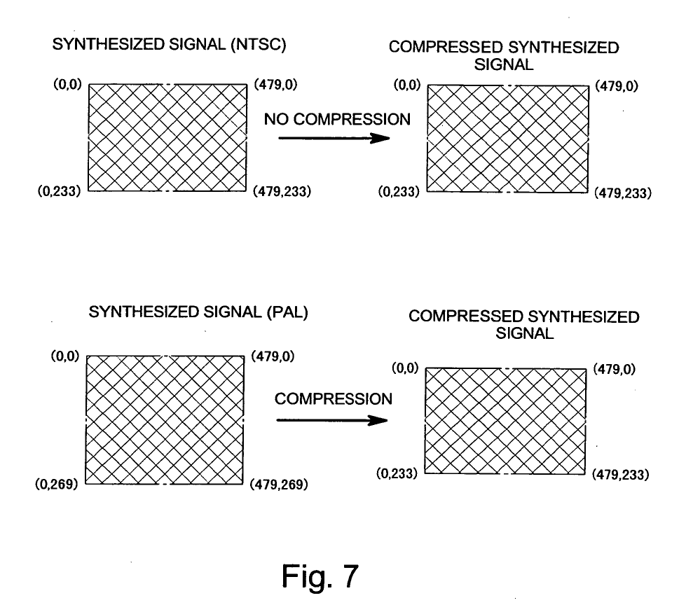

With this arrangement, the on-screen image can be displayed on the entire QVGA display screen as illustrated in FIG. 7, because the video signal and the on-screen image signal of a synthesized image are synthesized using the same number of pixels.

In this arrangement using a compression circuit, the switching signal may similarly be input from outside as shown in FIG. 1. Alternatively, as shown in FIG. 4, the video signal receiving circuit 40 may be configured to automatically determine the scheme of the video signal and then output the determined result as a switching signal to the compression circuit 70.

Using an embodiment of the present invention, appropriate on-screen images can be displayed in accordance with input video signals generated according to different schemes such as NTSC and PAL.

It should be noted that the most significant feature of the present invention is that the number of pixels in the vertical direction of an on-screen image is changed depending on the scheme of the video signal. Accordingly, actual configurations of the present invention are not limited to those described above. Modifications are possible within the scope of the present invention.

Although the above-described embodiments refer to cases in which a QVGA display is used, the advantages of the present invention can similarly be achieved when using a display having a different resolution, such as a WVGA display, by changing the number of pixels in the on-screen image.

1. A video signal processor, comprising:
a video signal receiving circuit for receiving a video signal;
a sub-image signal generating circuit for generating an on-screen image signal corresponding to a fixed-pixel on-screen image to be displayed overlapping a video image; and
an interface circuit for converting the video signal received by the video signal receiving circuit into a fixed-pixel video signal, and synthesizing the converted video signal with the on-screen image signal generated by the sub-image signal generating circuit; wherein
the sub-image signal generating circuit generates the on-screen image signal to include a number of pixels in a vertical direction changed in accordance with a scheme of the video signal.

2. A video signal processor as defined in claim 1, wherein the sub-image signal generating circuit comprises:
a horizontal counter for sequentially arranging data for each pixel in a horizontal direction of the on-screen image; and
a vertical counter for sequentially arranging data for each group of horizontally-arranged pixels of the on-screen image; wherein
the on-screen image signal is generated while changing, in accordance with the video signal scheme, a number to be counted by the vertical counter.

3. A video signal processor as defined in claim 1, wherein
a character to be displayed in the on-screen image is constituted using 18 pixels in the vertical direction, and
the sub-image generating circuit generates the on-screen image signal to include 234 pixels in the vertical direction when the video signal is according to NTSC scheme, and generates the on-screen image signal to include 273 pixels in the vertical direction when the video signal is according to PAL scheme.

4. A video signal processor as defined in claim 2, wherein
a character to be displayed in the on-screen image is constituted using 18 pixels in the vertical direction, and
the sub-image generating circuit generates the on-screen image signal to include 234 pixels in the vertical direction when the video signal is according to NTSC scheme, and generates the on-screen image signal to include 273 pixels in the vertical direction when the video signal is according to PAL scheme.

5. A video signal processor as defined in claim 1, further comprising a compression circuit for compressing a signal output from the interface circuit.

6. A video signal processor as defined in claim 2, further comprising a compression circuit for compressing a signal output from the interface circuit.

7. A video signal processor as defined in claim 5, wherein compression by the compression circuit is performed while changing a compression ratio depending on the video signal scheme.

8. A video signal processor as defined in claim 6, wherein compression by the compression circuit is performed while changing a compression ratio depending on the video signal scheme.

9. A video signal display device, comprising:
a video signal receiving circuit for receiving a video signal;
a sub-image signal generating circuit for generating an on-screen image signal corresponding to a fixed-pixel on-screen image to be displayed overlapping a video image;
an interface circuit for converting the video signal received by the video signal receiving circuit into a fixed-pixel video signal, and synthesizing the converted video signal with the on-screen image signal generated by the sub-image signal generating circuit; and
a fixed-pixel display for visually displaying a synthesized video signal output from the interface circuit; wherein
the sub-image signal generating circuit generates the on-screen image signal to include a number of pixels in a vertical direction changed in accordance with a scheme of the video signal.

10. A video signal display device as defined in claim 9, wherein
the display has QVGA resolution,
a character to be displayed in the on-screen image is constituted using 18 pixels in the vertical direction, and
the sub-image generating circuit generates the on-screen image signal to include 234 pixels in the vertical direction when the video signal is according to NTSC scheme, and generates the on-screen image signal to include 273 pixels in the vertical direction when the video signal is according to PAL scheme.
